(19) United States
(12) Patent Application Publication
(10) Pub. No.: US 2002/0103744 A1
(43) Pub. Date: Aug. 1, 2002

(54) Property futures exchange

(76) Inventor: Sean Reveille Llewelyn, Paradise Waters (AU)

Correspondence Address: JONES, TULLAR & COOPER, P.C., Eads Station, P.O. Box 2266, Arlington, VA, 22202, US

(21) Appl. No.: 09/775,645

(22) Filed: Feb. 5, 2001

Related U.S. Application Data
(60) Provisional application No. 60/180,125, filed on Feb. 3, 2000.

(51) Int. Cl. G06F 17/60

(52) U.S. Cl. 705/37; 707/3

(57) ABSTRACT

A property futures exchange wherein indices are created based on the selling prices of property sold, in respective areas, for a given time period. Futures contracts which are based on the indices are then traded in real time preferably on the Internet. The selling prices are preferably derived from official fiscal records.

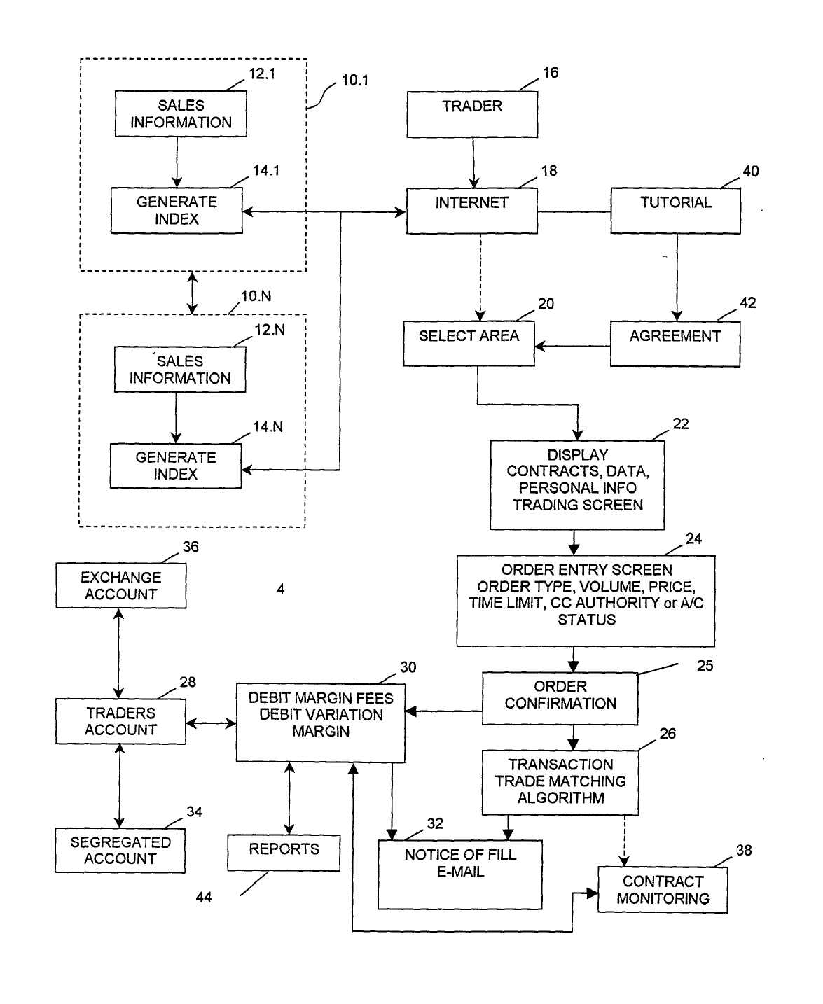

### BACKGROUND OF THE INVENTION

This invention relates generally to futures trading and more particularly is concerned with futures trading in property.

A futures contract may be regarded as a formal agreement between a buyer or seller and a commodity exchange. Generally in the case of a purchase contract the buyer agrees to accept a specific commodity that meets a specified quality in a specified month whereas, in the case of a sale, the seller agrees to deliver a specific commodity of a specified quality during a designated month.

To facilitate trading contracts must be uniform. For a particular commodity the contracts must be identical. Thus, apart from specifying the delivery month and location, the contract must specify the grade and type of the commodity and the units of the commodity so that, when an individual buys or sells a contract, there can be no doubt as to the nature of the obligation. The units of trading may however vary with each commodity although, for specific commodities, the units are standardized.

With commodities such as grain, oil seeds, metals, petroleum and the like it is relatively easy to develop contracts which are uniform. With property, however, given the individualism which is expressed in buildings and other developments, particularly residential developments, the underlying securities or commodities, i.e. houses or buildings, are not fungible. In other words the commodities are not negotiable in kind or by substitution, as is the case, for example, with a quantity of grain which is exchangeable for an equal amount of the same kind of grain. Clearly this mitigates against futures trading in property.

### SUMMARY OF THE INVENTION

The invention provides a method of trading in the value of property which includes the steps of:

(a) designating at least one geographical area;

(b) collecting data relating at least to the classification prices and numbers of properties which are located in the designated geographical area and which either are sold during a given time period or for which the registration of a transfer pursuant to a sale takes place during a given time period;

(c) generating an index from the collected data which is based at least on the selling price per property sold or transferred during the given time period;

(d) producing futures contracts for properties, in the said designated geographical area, which are based at least on the said index; and

(e) allowing the futures contracts to be traded on an exchange.

Preferably the method includes the step of ensuring credit-worthiness between traders: by debiting their credit cards; or by verifying accessible bank deposits of acceptable securities; or by requiring traders to deposit margin in an account maintained by an exchange with a bank (the “settlement bank”).

Although the futures contracts may be traded in any suitable way they are preferably traded in real time for example via the Internet.

The method may include the step of restricting trading of a contract, particularly in its spot month, to traders who have taken positions in that contract prior to the start of the spot month, and to the extent of such traders closing out (i.e. reversing) those pre-existing positions.

The said index may be generated on any suitable basis and for example may be related to the average selling price of all properties sold, the median selling price of all properties sold, or any other acceptable basis.

The data which is collected, which forms the basis for the index, may be derived from sources with acceptable integrity and preferably is derived from official, government or fiscal records.

A number of geographical areas, which may be selected according to various criteria, may be designated and, within each area, specific data may be collected and an appropriate index may be generated.

The method of the invention may allow for automatically debiting initial margin deposits pertaining to a specific trader and contract and for debiting and crediting variation margin according to the daily settlement prices of the respective contracts.

The size (nominal value) of each contract may vary according to requirement and prevailing conditions and for example may be a proportion, e.g. 10%, of the median price, or of any other appropriate representative price, of properties in the respective designated geographical area.

The properties, upon which the trading method is based, may be classified in any appropriate way e.g. houses, apartments, areas of fixed structures on the properties, addresses within the designated geographical area, state of repair, and the like.

### BRIEF DESCRIPTION OF DRAWING

The invention is further described by way of example with reference to the accompanying drawing which is a block diagram representation of the operation of a property futures exchange in accordance with the principles of the invention.

### DESCRIPTION OF PREFERRED EMBODIMENT

The accompanying drawing is block diagram representation of the operation of a property futures exchange in accordance with the principles of the invention.

It is an object of the invention to provide an exchange through which one can trade in the value of residential property in designated geographical areas, for example in the major cities or areas of the world such as London, New York, Sydney, San Francisco and the like, and areas within such cities.

By creating residential property futures contracts people wishing to buy property, but who do not have sufficient funds, or who cannot find the correct property, can nevertheless obtain an economic interest in the chosen class of property.

Conversely people who own property, or to whom property is mortgaged, and who are concerned about a reduction in the value of such property can protect their interest without having to undergo the process of actually selling the property.

A key aspect of the invention is the use of an index which is derived from all selling prices of property within a specified geographical area. Contracts are established and are cash settled against that index.

If the exchange is operating in respect of residential property it is clearly a requirement to have customers who either own or wish to own residential property the value of which is worth hedging. The customers also need to be sufficiently educated to understand the concept and implications of futures trading. The customers need to have financial means and facilities which will enable them to participate in the futures market.

Another aspect is that records pertaining to property transactions must be readily available and must have absolute integrity. The records must also be updated at regular intervals. In many countries property can only be acquired through the medium of written agreements which reflect the purchase prices of the properties in question. These prices are used for calculating duties and taxes, which may comprise stamp duties or which may be in any other form, and which are paid on the value of each transaction. Without payment of such duties and taxes registration of the transfer will not take place. It would be highly desirable therefore and possibly essential, to have access to official records, or summaries thereof, which are maintained in terms of an underlying legislative or statutory structure.

The accompanying drawing reflects a plurality of areas designated area 10.1 . . . area 10.N respectively. Within each area sales information 12.1 . . . 12.N is derived from a suitable record source, and from that information an index is generated (step 14.1 . . . 14.N).

Each area is well defined and, within the area, the nature of the property in question is defined e.g. a single dwelling with a single title deed, a residential dwelling in the nature of an apartment or condominium which may be subject to a share title scheme, or the like. Clearly the nature of the legal rules which govern ownership will vary from country to country and, within any country, may vary from state to state or from a sub-region to a sub-region.

The index which is generated is derived from all sales prices or transfers recorded within each area and may be the median or average price for a given period, or a more complex system may be utilized for generating the index, the object of which is to provide an indicator of true property prices in buy and sell transactions, in the area.

The futures trading system of the invention is made available on a real time basis to traders 16 via the Internet 18.

A trader connects to the Internet and logs onto the site of the exchange. If the trader has previously been registered then the homepage directs the user to the first trading screen which lists all the contracts available.

An initial sequence comes into operation in respect of a prospective trader i.e. a trader who has not previously been registered. This is described hereinafter.

The trader selects an area (step 20) and in a subsequent display 22 the available contracts in the area can be viewed. Preferably this is in conjunction with a map which provides relevant demographic data. Menus, selectable by the trader, enable displays to be given for the contract, historical data such as price, volume and open interest, a trading screen, personal account information pertaining to the trader, and the like.

The trader selects the trading screen (step 24) which shows all the contract periods for a given area, say monthly for three years, and the available orders which he may enter. These are of four order types which execute according to a trade matching algorithm which matches trades on a strict price/time priority basis (step 26). This means that resting orders at a given price would be filled in the sequence in which they were entered into the system.

All orders can be entered as day-only, or good-till-filled (“GTF”). The day-only orders would be cancelled automatically if unfilled at the close of the day's trading session; while the GTF basis allows the order to remain in the system until matched or cancelled. The orders are:

Limit Orders

These specify a price at which a trader wishes to buy or sell, and would match only at the limit price or better.

Market Orders

A market order to buy (sell) would match the best available limit offers (bids) in price/time order until the market order had been filled entirely or until there are no more limit orders against which it could be executed, in which case it would be cancelled.

Stop and Market-if-Touched (“MIT”) Orders

A sell stop order is placed below the current market price, while a sell MIT is placed above it; and the reverse applies for buy orders. Stop and MIT orders become market orders when triggered except—that the unfilled portions are not cancelled.

At this point, the trader enters his desired contract month, volume, order type, price (except for market orders) and time limit (step 24). The system either obtains an authorisation number from the trader's credit card supplier, or verifies that sufficient margin is deposited in the settlement bank. If margin is secured, the system invites the trader to confirm the order by displaying a page showing the terms of the order as well as the trader's account balance, the exchange's fee and the trader's account equity (step 25).

If confirmed by the trader, the order is entered into the system, an order number assigned and it is immediately available to be acted upon by the trade matching algorithm (26). Initial margin is debited from either the trader's credit card account, his account at the settlement bank (step 28) or any other acceptable account, and electronically transferred into a segregated account earning interest on the trader's behalf at the settlement bank (step 34), and the applicable fees for the transaction are transferred to an account 36 operated by the exchange. The amounts in the segregated account are clearly reserved for the trader although, if a trader defaults, that trader's account is accessible by the exchange or clearing system to recover its losses. When a trade is matched by the system, a notice of fill is sent out immediately to each trader via e-mail showing the order number, price, time of fill and volume (step 32). The credit-worthiness of a trader can be established in any other acceptable way, apart from directly debiting an account of the trader, e.g. by verifying accessible bank deposits of acceptable securities.

All monies pertaining to a particular contract are in the denomination or currency of the country in which the contract applies.

The user now has an economic interest in the value of residential property in the chosen designated area and can monitor that interest (step 38) at any time by logging onto the homesite of the exchange. As the daily settlement prices vary, in respect of contracts which are dealt in the area, variation margin is debited (step 30), at a prescribed rate, from the trader whose profit/loss position has deteriorated from the previous daily settlement price, and credited (step 30) to his counter party via their respective credit card accounts or accounts at the settlement bank, together with an administrative fee to the exchange.

At contract settlement the variation margin is gained or lost to the trader, depending on which side of the contact he is on and the initial margin, plus interest, is returned, less any shortfall in the variation margin.

As is customary with futures trading the user does not have to wait until settlement in order to crystallise any gains or losses. The user can reverse his trade, although this most probably will be at a different price and, from that payment onwards, his margin remains a net constant figure to which interest is gained or lost.

A potential trader, i.e. a user who has not previously been registered, who logs onto the system will not be permitted by the system to trade unless the whole of the homesite of the exchange has previously been navigated by the user. This is indicated by means of a step 40 in the accompanying flow chart. The homesite provides a description of the exchange and its activities and a preliminary tutorial is presented which cannot be avoided by a new user. Interactive examples are provided for the user to work through and a margin tutorial is given. Further interactive examples are provided explaining the effects of initial and variation margins. A risk disclosure statement is provided by the exchange and the user must complete an undertaking of understanding before moving on.

The areas of the world in which contracts are offered are shown in either map or menu form and the user is invited to choose a city and then a part thereof. If it is a foreign city, the currency exchange rate between that foreign country and the country of the user is presented.

Appropriate contract specifications are highlighted and, again, the user must provide an undertaking that he has read and understands the contract. The user is then presented with a registration form which includes credit card or other approved account information which will apply to all transactions which may be entered into by the user. Upon completion of registration the user is invited to submit a password and is given a unique identification number and account number with which to deal. In essence therefore the user is asked online to enter into an agreement 42 with the exchange and only if all of the preliminary steps are adequately and satisfactorily completed is the user permitted to advance to actual trading. Once the agreement has been completed the full contract, which pertains to actual trading, is presented and the user must undertake that he has read and understands the contract whereafter the trading screen appears and the user may trade. In subsequent visits, the user may go straight to the trading screen after logging on with his name, password, identification number and contract number.

As is the case with conventional commodity exchanges the size of a contract is defined in advance. For example assume that the index price of residential property in part of a chosen city is $500,000. The contract size might be set at 10% or $50,000 and the initial margin may be set at 10% of the index i.e. at $5,000. Exchange fees would be set to a percentage e.g. of the order of 0.5% of the contract i.e. at $250.

An essential part of the trading of property futures as envisaged by the present invention is the integrity of the data from which the indices pertaining to the respective geographical areas are derived. As has previously been stated herein in most advanced societies property is acquired through the medium of written agreements and taxes, e.g. in the form of stamp duties or in other form, are levied on the values of the transactions. Generally it is the purchaser's obligation to pay such duties and consequently legislative requirements generally call for the contract documents to be lodged with a government office and for the fiscal payment to be made in a prescribed manner. Transfer of a property will not be registered unless all formalities have been complied with.

Thus a repository of market values of all real property transfers is inherently created in the proper administration of property tax, stamp duty, valuation or title deed records. It is evident that what is required is either access to these records or summary data thereof prepared by the relevant government office and that these records must be updated at regular intervals.

The integrity of the data, which forms the basis of the trading system of the method of the invention, must be secured. It may be necessary to adapt the method of the invention to ensure that insider or unlawful trading does not take place. For example it is the practice in certain jurisdictions for the government agency which is charged with compiling the property sales data to release that data on a batch basis e.g. monthly. This would mean that, as a contract month becomes the spot or cash month and physical property transactions are registered, the staff of the relevant agency would develop an increasingly accurate estimate of that month index value as the month progresses. If the staff were able to trade on this 115 information there would be no integrity in the market. One solution to the problem is to restrict trading of a contract in its spot month only to traders:

(a) who have taken positions in that contract prior to the start of the spot month, and

(b) only to the extent of such traders closing out (i.e. reversing) those pre-existing positions.

With this type of restriction no trader is able to initiate a new position on a contract in its spot month and integrity is maintained in the market provided there is sufficient liquidity in the spot month. Normally there will be a delay of some days between the end of the spot month and the release of the index data and during this period traders will be in limbo vis a vis their profit/loss situations on open positions. On the other hand the mechanism enables an index based market to operate tolerably in circumstances where it would otherwise not be viable due to the batch release of data from which the index is constructed and the class of persons who are privy to that data prior to release thereof.

There should also be meaningful volatility in the values obtained from a particular area, particularly so that customers realise that their anticipated prices may differ significantly from those prevailing at a given time.

A suitable index would be one which is based on median values as opposed to mean values of property transactions. If diverse locations are included in a designated area then a weighted average of the median values may be used for producing the index, or some other statistical manipulation which is appropriate in the circumstances may be adopted, possibly including hedonic information.

As has been stated in the preamble a traditional difficulty standing in the way of trading in property futures is the lack of fungibility. By adopting indices for designated areas a fungible commodity is, in effect, established. Of equal importance, however, are the specifications of the contracts. Each contract should cover or address the following:

(a) the area which is covered;

(b) the property classification which is based on the nature of the residential property e.g. a single dwelling subject to a single title deed; an apartment; the area of the fixed structure; the area of the ground; the address of the property; etc. Clearly the classification is important, but it is possible to develop appropriate standardised parameters, although some measure of subjectivity may prevail;

(c) the registration in the land titles office of transfers in a period;

(d) the transfer values as recorded by the particular office;

(e) settlement e.g. against the median value of all transfers in that period;

(f) the period for which the contract is valid;

(h) the size of the contract;

(i) the expiry date of the contract;

(j) the initial margin and variation margin rules;

(k) the mechanism for collecting and paying the margin calls;

(l) close out procedures at contract settlement; and

(m) fees for the exchange.

The system of the invention, in order to be effective, requires certain essentials namely:

(a) private property ownership;

(b) ownership evidenced by registration of title;

(c) a state, or sub-region, tax or duty which is payable on the contract value and a transfer; and

(d) public availability of transaction data.

Through the medium of the invention people wishing to purchase property but who do not have sufficient funds or cannot find a suitable property, can nevertheless obtain an economic interest in such property and, conversely, people who own property, or to whom property is mortgaged, and are concerned about a reduction in value can protect themselves without going through the process and expense of selling their property.

It is also possible to trade options on the futures. If (in a normal circumstance) a trader exercises a long call option he will acquire a long futures contract plus a cash amount equal to the excess of the futures price over the strike price of the option. If (in a normal circumstance) the trader exercises a long put option he will acquire a short futures contract plus a cash amount equal to the excess of the strike price of the option over the futures price. In each case, after exercise of the option, a new position in the underlying futures contract has been created and the option is extinguished. These new futures contracts are identical to all others, however created.

Clearly the trading method of the invention must conform fully with all applicable legislation. In most countries this would require that the trading system must be licenced and regulated by the appropriate authorities. In the US this would probably mean licensing and regulation by the CFTC. In order to comply with statutory requirements therefore all transactions which are effected through the trading system of the invention are automatically monitored, in a fail proof manner, by suitable software which is not accessible by the trader. Such software prepares reports (step 44), in a suitable medium and at appropriate time intervals, in order to comply with all applicable obligations of the regulatory authority.

1. A method of trading in the value of property which includes the steps of:
(a) designating at least one geographical area;
(b) collecting data relating at least to the prices and numbers of properties which are located in the designated geographical area and which either are sold during a given time period or for which the registration of a transfer pursuant to a sale takes place during a given time period;
(c) generating an index from the collected data which is based at least on the selling price per property sold or transferred during the given time period;
(d) producing futures contracts for properties, in the said designated geographical area, which are based at least on the said index; and
(e) allowing the futures contracts to be traded on an exchange.

2. A method according to claim 1 which includes the step of ensuring credit-worthiness between traders by at least one of the following: debiting their bank accounts or credit cards; verifying accessible bank deposits of acceptable securities.

3. A method according to claim 1 which includes the step of requiring traders to deposit margin in an account maintained by an exchange with a bank.

4. A method according to claim 1 wherein the futures contracts are traded according to a trade matching algorithm operated by the exchange.

5. A method according to claim 1 which includes the step of restricting trading of a contract to traders who have taken positions in that contract prior to an event.

6. A method according to claim 5 wherein the said event is a spot month of the said contract.

7. A method according to claim 1 wherein the said index in step (c) is related to at least the average or median selling price of all properties sold.

8. A method according to claim 1 wherein the said data which is collected is derived from official, government or fiscal records.

9. A method according to claim 1 wherein, in step (a), a number of geographical areas are designated and, within each area, specific data is collected and an appropriate index is generated.

10. A method according to claim 1 which includes the steps of automatically debiting initial margin deposits pertaining to a specific trader and contract and debiting and crediting variation margin according to the daily settlement prices of the respective contracts.

11. A method according to claim 10 wherein the nominal value of each contract is a proportion of the median, or other representative, price of properties in the respective designated geographical area.
